(19) United States
(12) Patent Application Publication
(10) Pub. No.: US 2019/0044699 A1
(43) Pub. Date: Feb. 7, 2019

(54) RECONFIGURABLE GALOIS FIELD SBOX UNIT FOR CAMELLIA, AES, AND SM4 HARDWARE ACCELERATOR

(71) Applicant: Intel Corporation, Santa Clara, CA (US)

(72) Inventors: Sudhir Satpathy, Hillsboro, OR (US); Sanu Mathew, Portland, OR (US); Vikram Suresh, Portland, OR (US)

(73) Assignee: Intel Corporation, Santa Clara, CA (US)

(21) Appl. No.: 16/021,526

(22) Filed: Jun. 28, 2018

(51) Int. Cl. H04L 9/06

(52) U.S. Cl. CPC H04L 9/0631; H04L 9/0618

(57) ABSTRACT

Methods and apparatus for a reconfigurable Galois Field (GF) Sbox unit for Camellia, AES, and SM4 hardware accelerator are described. In one embodiment, a modified Substitute box (Sbox) leverages a common field of GF to incorporate a multi-cipher mode of operation. The hybrid Sbox design can reduce area and/or energy consumption. Other embodiments are also described and claimed.

### FIELD

The present disclosure generally relates to the field of computing. More particularly, an embodiment generally relates to reconfigurable Galois Field (GF) Sbox (Substitution box or Substitute byte) unit for Camellia, AES, and SM4 hardware accelerator.

### BACKGROUND

In cryptography, a block cipher may be a symmetric key cipher which operates on fixed-length groups of bits referred to as “blocks.” For example, during encryption, a block cipher may take a 128-bit block of plaintext as input and output a corresponding 128-bit block of ciphertext in accordance with a secret key. For decryption, the 128-bit block of ciphertext and the secret key may be used to determine the original 128-bit block of plaintext.

Block ciphers are key building blocks of most if not all security protocols for content protection, secured communication and data authentication. Although the Advanced Encryption Standard (AES) has been the de facto standard of use for many years, recently new symmetric key ciphers like SM4 and Camellia are becoming standardized in different regions and applications. For example, the SM4 cipher that was declassified by the Chinese National Security agency in 2008 was later mandated to secure all wireless network traffic in China in 2012. Similarly, the Camellia cipher that was selected for adoption in Japan's new e-Government Recommended Ciphers List in 2013 is now used in applications like VeraCypt™ (utility for disk encryption), Gnu's Not Unix (GNU) Privacy Guard, etc. Hence, there is motivation to develop a unified platform to accelerate AES, SM4, and incorporate Camellia.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates comparison information for some characteristics of AES, SM4, and Camellia Sboxes.

FIG. 2 illustrates a block diagram of operations performed by a hybrid AES/SM4/Camellia Sbox, according to an embodiment.

FIG. 3 illustrates exemplary mapping to and from AES/SM4/Camellia to GF(2⁴)² composite field, according to an embodiment.

FIG. 4 illustrates a block diagram of AES, SM4, Camellia Sbox expressions in GF(2⁴)², according to an embodiment.

FIG. 5 shows a block diagram of further details of pre and post inverse transforms for AES, SM4, Camellia cipher modes, according to some embodiments.

FIG. 6 shows a block diagram of further details of inversion logic for inverse computation in GF(2⁴)², according to an embodiment.

FIG. 7 shows a sample plot for an optimal polynomial choice for AES and SM4, according to an embodiment.

FIG. 8 illustrates a graph which plots the area of the hybrid Sbox for several cases, according to an embodiment.

FIG. 9 illustrates a block diagram of components for random switching between optimal and sub-optimal GF transforms for side-channel leakage mitigation, according to an embodiment.

FIGS. 10 and 11 illustrates block diagrams of embodiments of computing systems, which may be utilized in various embodiments discussed herein.

FIGS. 12 and 13 illustrate various components of processors in accordance with some embodiments.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, there is motivation to develop a unified platform to accelerate AES, SM4 (which may be referred to herein interchangeably as “SMS4”), and incorporate Camellia. Sbox is the performance and power critical operation in most symmetric key block ciphers. As opposed to other operations like rotation, shift and addition that are similar across ciphers, Sbox is uniquely specified for every cipher standard as a table that serially lists the output for every possible input. Storing this table in a LUT (Look Up Table) or register file macro is one approach to implement the Sbox. This relatively simple approach allows sharing the LUT/register file across multiple ciphers by re-populating the entries while switching from one cipher to the next. However, the large area penalty and lack of synthesizability render such custom macros not attractive for cipher accelerators.

Furthermore, the cipher transition latency overhead degrades overall encryption/decryption throughput. Alternative approaches for implementing Sbox using Galois Field (GF) arithmetic improve area/energy efficiency, but the different generator/reduction polynomials that determine hardware complexity limit logic reuse, and may require complete re-design of all elementary arithmetic blocks for multiplication, squaring, inversion etc. to incorporate multiple ciphers. Besides, lack of configurability limits the scope of incorporating any additional cipher post production through firmware update.

To this end, some embodiments provide a reconfigurable Galois Field (GF) Sbox unit for Camellia, AES, and SM4 hardware accelerator. One embodiment provides a hybrid Sbox that leverages GF isomorphism to efficiently incorporate multi-cipher mode of operation, e.g., eliminating the need for multiple arithmetic blocks corresponding to different cipher generator polynomials. Another embodiment presents an optimization scheme to select the best pair of polynomials that minimizes Sbox area, which further improves the efficacy.

For example, the hybrid Sbox may compute all critical operations in an optimal field, e.g., only requiring a pair of transformations to map operands to and from the standard specified cipher field. A reconfigurable field transformation logic can hence accelerate additional cipher Sbox operating modes by leveraging efficient computing in the optimal field. This additional feature allows for incorporation of acceleration for new ciphers in future in addition to AES, SMS4, and Camellia without changing the underlying hardware.

For example, in addition to improving the area and energy-efficiency of hardware accelerators, the hybrid Sbox implementation and optimization techniques described herein can be used in programmable platforms like FPGA (Field-Programmable Gate Array) and software/firmware as well to impact multiple products.

Moreover, the reconfigurable mapped affine transformations may be used in conjunction with the optimally mapped transforms to improve side channel resistance by randomly selecting one or the other for every cipher Sbox operation. As discussed herein, an “affine” transformation generally refers to an operation where an input byte is multiplied by an 8×8 matrix and then added to a constant vector. For example, for input x, the operation is Ax+B, where A is the 8×8 matrix and B is the 8 bit vector. Although the key ideas described herein are targeted towards area reduction and energy-efficiency improvement in a multi-cipher usage scenario, the presence of reconfigurable features in various embodiments can also be opportunistically used to mitigate side-channel information leakage.

The Sbox operation in AES, SMS4, and Camellia can be decomposed into an inversion operation and two affine transformations. The affine transformations involves multiplication of a byte with a standard specified 8×8 matrix followed by addition of a constant, whereas the inversion operation relies on complicated GF multiplication, squaring and scaling steps that depend on the cipher generator polynomial. Mapping the input bytes from their respective standard specified Galois-Field (with a corresponding generator polynomial), to a common composite field of GF(2⁴)² allows inversion sharing, significantly reducing logic complexity.

In an embodiment, merging the mapping and inverse mapping logic to the pre-inverse and post-inverse affine transformation matrices, respectively, enables GF(2⁸) to GF(2⁴)² conversion without any logic overhead, while simplifying inversion implementation owing to reduced bit-width elementary operations.

In one embodiment, a two-step optimization scheme prunes down the polynomial search space by first selecting the optimal GF(2⁴)² field for AES and SMS4 out of 23,040 choices, and subsequently selects the most efficient mapping matrices among 128 choices to transform Camellia operands to this optimal field. Moreover, the GF(2⁴)² composite field is defined by a pair of irreducible polynomials, called the ground-field and the extension-field polynomials. The three choices for ground-field and 120 choices for extension-field, result in a total of 2,880 candidates for AES Sbox. The SMS4 Sbox can be mapped onto each of these AES Sboxes in eight ways, resulting a total of 23,040 unified AES-SMS4 Sbox candidates. After the GF(2⁴)² field for AES-SMS4 is selected, the CML (or Camellia) field can be converted to the AES-SMS4 field with 128 choices.

Augmenting the hybrid Sbox with a pair of reconfigurable pre/post-inverse affine matrices enables incorporating other cipher Sbox modes of operation during run-time and leverages existing hardware to accelerate new encryption/decryption standards. Because the inversion logic dominates the hybrid Sbox comprising of about 60% of total area, the reconfiguration logic incurs little overhead and does not impact critical path delay. While operating in AES, SM4, or Camellia cipher modes, these reconfigurable matrices can be programmed to generate a parallel datapath that is functionally equivalent (but higher power) to one of the optimally mapped AES/SM4/Camellia datapath. A random number can be used to select/activate one of the data paths (either cipher specific optimal or reconfigurable sub-optimal) for every Sbox operation to inject noise into the current signature, thus breaking the correlation between Sbox power consumption and operands.

One embodiment utilizes a hybrid Sbox and optimization scheme to enable a unified cipher accelerator datapath implementation providing about 37% area savings for AES-SMS4 acceleration over prior Best Known Methodology (BKM) accelerator designs while simultaneously speeding up Camellia Sbox operation. Also, replacing the existing Sbox with the proposed design allows supporting Camellia, e.g., enabling about a ten-fold speed-up over conventional micro-code based implementations.

In addition, current symmetric key cipher accelerator IPs may lack any programmability rendering them inefficient in handling any new cipher in future without significant re-design. The reconfigurable fused mapped affine transformation schemes described herein enables seamless adaptation of new cipher modes of operation enabling faster time to market for products. These reconfigurable transforms also provide a unified side-channel leakage mitigation technique for all three ciphers enabling significant area savings over BKM approaches that may explicitly duplicate the Sbox for each cipher operation mode to generate different current signatures.

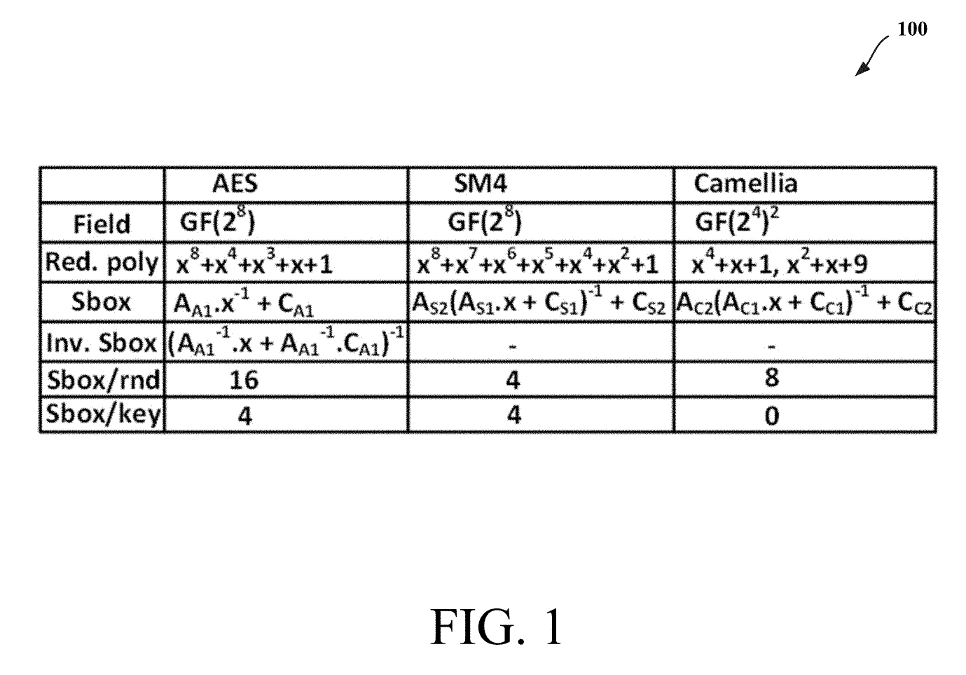

FIG. 1 illustrates comparison information 100 for some characteristics of AES, SM4, and Camellia Sboxes. As shown, the field, reduction polynomial, Sbox, inversion Sbox, Sbox rounding, and Sbox key are shown for each cipher. As mentioned above, Sbox is the most performance and power critical step that dominates the round computation and key expansion logic of many block cipher accelerators. The large number of Sboxes used in Camellia (Japanese cipher), AES (NIST cipher), SM4 (Chinese cipher) contribute to up to about 60% of round logic. Hence, an efficient Sbox implementation is key to improving encryption and decryption performance/energy-efficiency. Although AES has been the de-facto cipher standard that is most commonly used for encryption, new ciphers like SM4 and Camellia are recently becoming popular being mandated/preferred by respective regional authorities for content protection. As shown in FIG. 1, SM4 and Camellia Sbox logic is considerably different from AES. In addition, the Galois-Field and the corresponding generator polynomials that determine elementary field operations like multiplication, squaring, scaling, inversion, etc. are vastly different, limiting the scope of logic re-use across these ciphers.

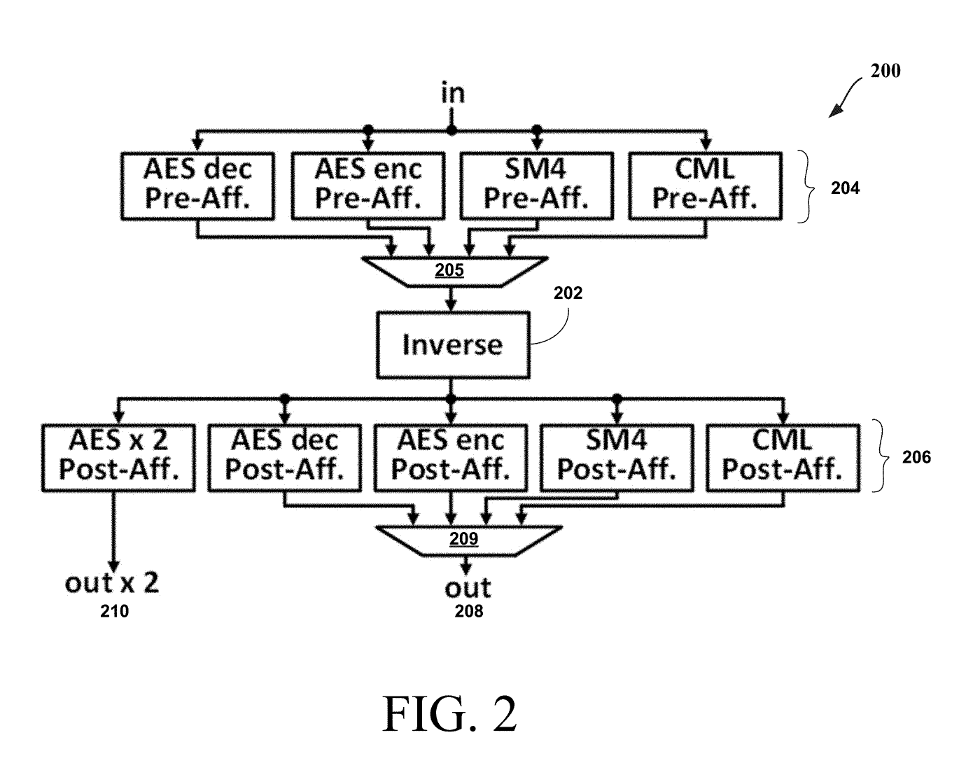

FIG. 2 illustrates a block diagram 200 of operations performed by a hybrid AES/SM4/Camellia Sbox, according to an embodiment. BKM Sbox design methodologies that are based on LUT/register-file storage or Galois-Field arithmetic are either area inefficient and not synthesis conducive or lack configurability to support multiple cipher standards. To this end, an embodiment proposes a hybrid Sbox that can seamlessly operate in one of Camellia, AES or SM4 modes, thus eliminating the need to duplicate elementary building blocks corresponding to each cipher specific generator polynomial. The proposed approach decomposes the Sbox operation into an inverse operation 202 and a pair of affine transformations (e.g., pre-affine transformations 204 (the output of which are combined via multiplexer 205) and post-affine transformations 206) as shown in FIG. 2. As opposed to conventional cipher accelerator datapaths that compute the inverse using their respective generator polynomials, the hybrid Sbox uses a common composite field of GF(2⁴)² for inversion 202, enabling logic sharing across all cipher operation modes. This approach performs conversion of input bytes from the standard specified Galois-Fields to the common GF(2⁴)² by multiplying mapping matrix. The pre-affine logic blocks 204 in FIG. 2 incorporate this multiplication along with the respective affine transformation matrix operations (where “CML” refers to Camellia, “AES dec” refers to AES decryption, and “AES enc” refers to AES encryption).

In contrast to AES, where all shift operations prior to Sbox are byte aligned, the SM4 standard rotates 128b data by 2, 10, and 18 bits resulting in misaligned bytes. This results in conversion of all bytes back to their original respective field before processing the subsequent round. In an embodiment, this is accomplished using a set of inverse-mapping matrices that are incorporated into the post-affine logic blocks 206 to map the Sbox results back into respective original fields as shown in FIG. 2. In AES encryption mode of operation, the Sbox doubles the output by multiplying an additional matrix for a more efficient implementation of mix-columns operation, where scaling is accomplished by selectively adding the Sbox original output 208 (which is the result of outputs of transformations of blocks 206 via multiplexer 209) and doubled output 210. Moreover, the AES mix-columns operation results in multiplying the Sbox output by three. Instead of performing an explicit multiplication by three, an embodiment generates the doubled output alongside the original output, and adds them. This speeds-up the multiplication by three step.

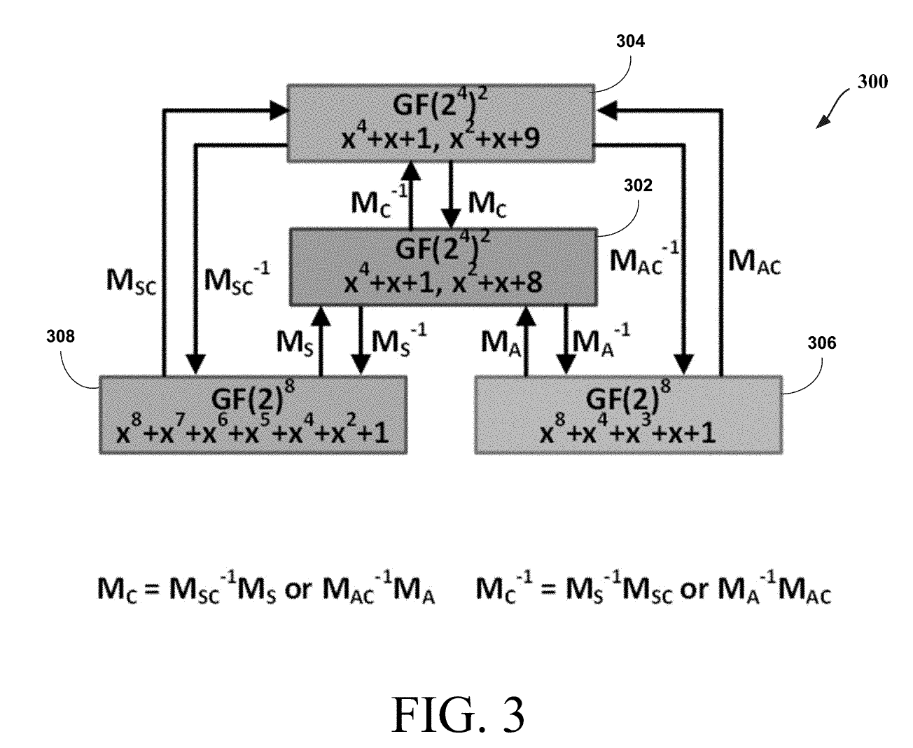

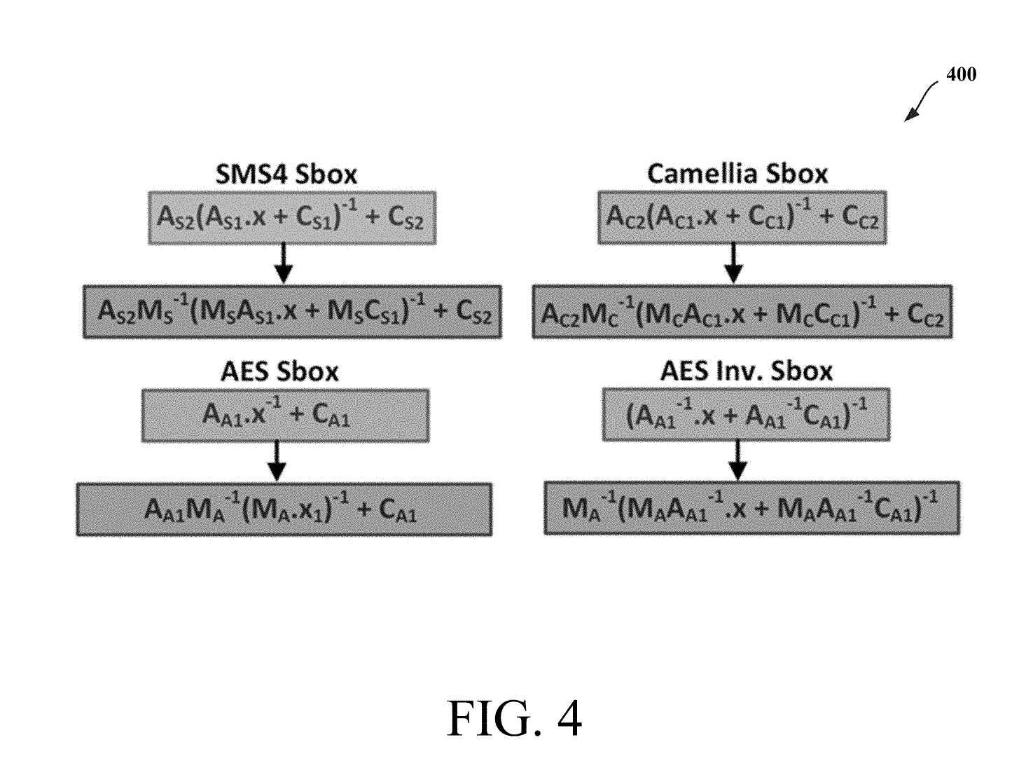

FIG. 3 illustrates exemplary mapping 300 to and from AES/SM4/Camellia to GF(2⁴)² composite field, according to an embodiment. The elementary GF operations in AES/SM4 and Camellia are governed by generator polynomials in GF(2⁸) and GF(2⁴)², respectively, as specified in FIG. 3. These operations in GF(2⁸) use 8>8 multiplication and 16 bit reduction circuits, that can be expensive to implement. As a solution, an embodiment uses a composite field Sbox that enables a more area efficient implementation of the inverse operation. Inverse calculation in the composite field of GF(2⁴)² is accomplished using simpler 4-bit multiply and 8-bit reduction operations in contrast to 8-bit multiply and 16-bit reduction in the original field of GF(2⁸). Mapping matrices M_{A}, M_{S}, and M_{C} convert AES, SM4 and Camellia cipher bytes from their respective Galois-Fields to a common GF(2⁴)² as shown in FIG. 3 (where 302 corresponds to the optimal field, 304 corresponds to Camellia field, 306 corresponds to AES field, and 308 corresponds to SMS4 field). In turn, the original Sbox expressions in FIG. 1 is transformed into new expressions as described in FIG. 4.

FIG. 4 illustrates a block diagram 400 of AES, SMS4, Camellia Sbox expressions in GF(2⁴)², according to an embodiment. The mapping and inverse mapping matrices in FIG. 4 can be merged into their respective Affine matrices to generate new mapped affine transformations without impacting critical path delay, thus (e.g., completely) amortizing the overhead of field transformation in some embodiments. In FIG. 4, every pair of A and C is an affine transform. For example, for input x, the affine transformation performs Ax+C, where x is 8 bits, A is an 8×8 matrix that is defined in the standard and C is 8 bits defined in the standard.

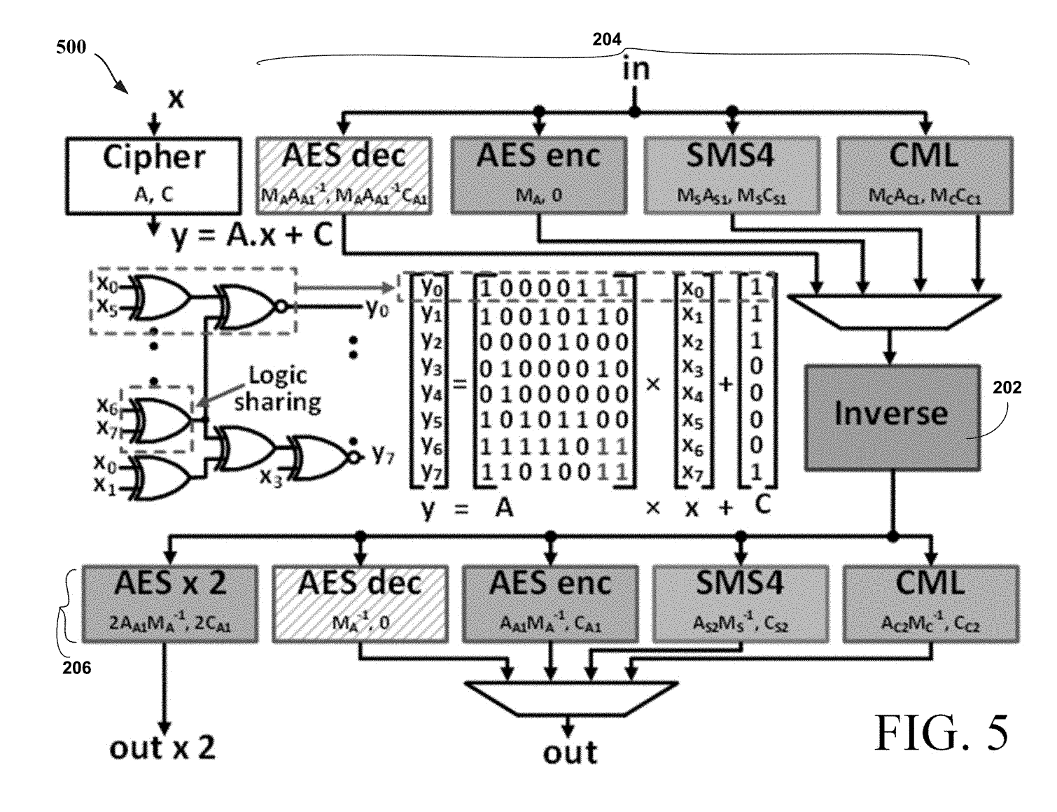

FIG. 5 shows a block diagram 500 of new pre and post inverse transforms for all three AES, SMS4, Camellia cipher modes in more detail, according to some embodiments. In one embodiment, FIG. 5 illustrates various components of a hybrid Sbox with mapped affine transforms. Multiplication (e.g., performed by XOR logic as shown) of multiple 8×8 constant matrices generates a final 8×8 matrix with similar logic complexity. Hence, all the new transforms can be implemented in a similar fashion as the old ones. In an advanced version of this implementation, a pair of reconfigurable pre/post Affine matrices can be included that can be programmed post manufacturing (by specifying A, C in FIG. 5) to incorporate a new cipher Sbox in addition to AES, SM4, and Camellia.

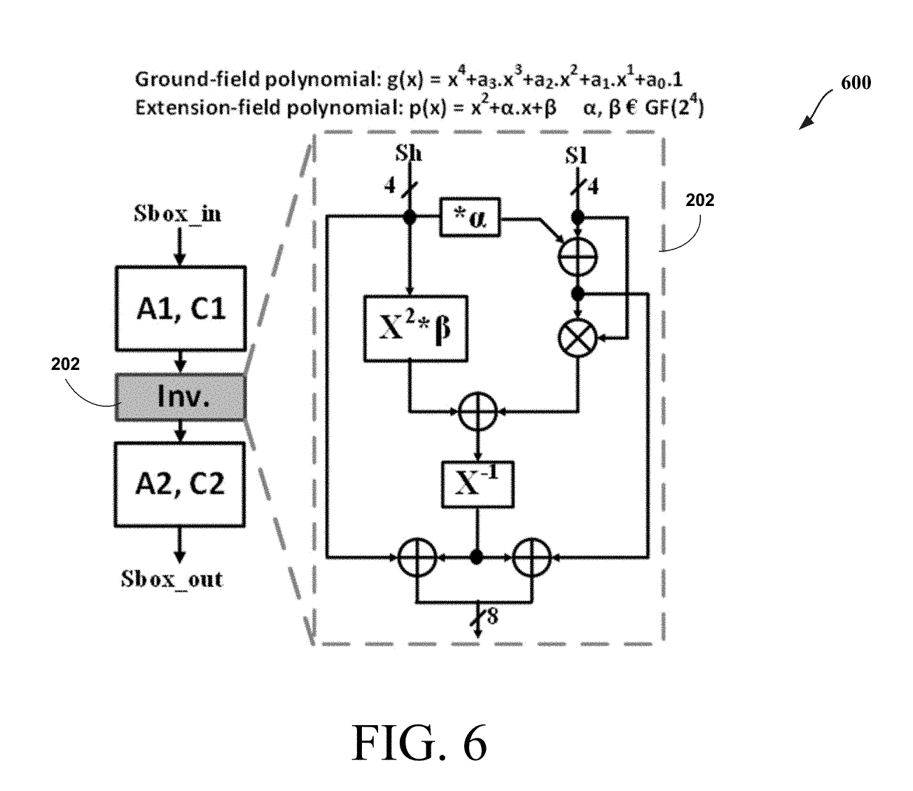

FIG. 6 shows a block diagram 600 the inversion logic for inverse computation in GF(2⁴)² in more detail, according to an embodiment. the inversion logic computes an 8b result using 4b multiplication, squaring and scaling operations. Arithmetic in the common composite field of GF(2⁴)² is defined by a pair of irreducible polynomials, called as the ground-field and the extension-field polynomials (g(x) and p(x), respectively). In FIG. 6, Sh and Sl are the four higher order and four lower order bits of the input, respectively. Alpha and beta are 4-bit parameters to define one of the polynomials of the GF(2⁴)² field and X⁻¹ is an inversion. Further, these polynomials not only determine the mapping and inverse mapping matrices, but also the complexity of various building blocks of the inversion module. Hence, the hybrid Sbox datapath can be further optimized by choosing the composite field that leads to simpler circuits with lower area.

One embodiment provides a two-step process to select the optimal polynomials and mapping transforms. The AES and SM4 round logic have a longer critical path delay compared to Camellia because of complicated mix-columns and key expansion logic. Unlike AES/SM4, each Camellia round involves only one addition following the Sbox operation and does not need an in-line key expansion. Hence, the hybrid Sbox critical path limits only AES and SM4 throughput. As such, this optimization framework initially prioritizes the arithmetic for AES and SM4, and later maps Camellia transformation matrices to the GF(2⁴)² field that minimizes AES/SM4 Sbox area.

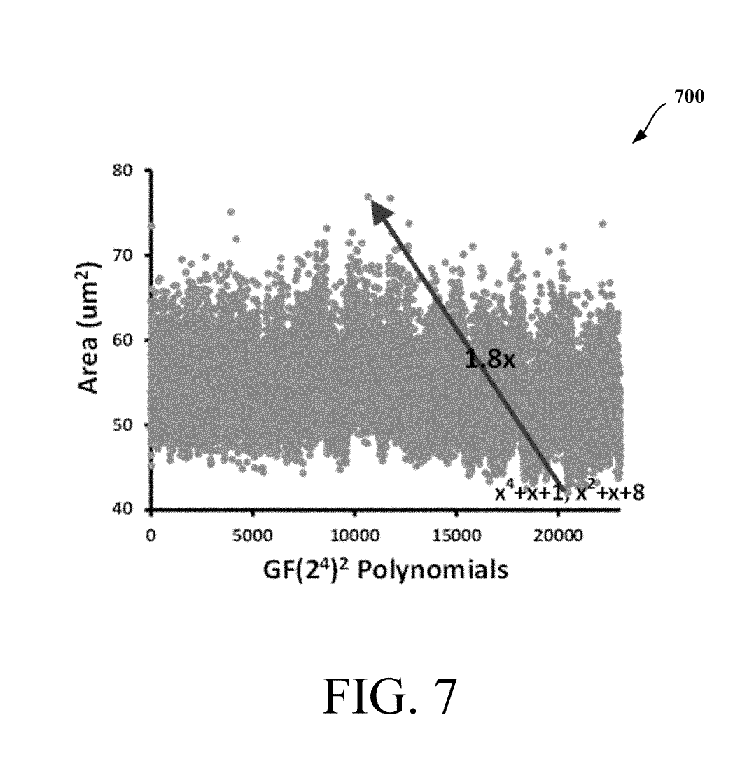

FIG. 7 shows a sample plot 700 for an optimal polynomial choice for AES and SM4, according to an embodiment. The plot in FIG. 7 shows hybrid AES SM4 Sbox area for different candidate composite field polynomial pairs. Exploration of the entire design space of 23,040 polynomials in a 14 nm tri-gate CMOS (Complementary Metal-Oxide Semiconductor) process, shows a 1.8× spread in area. Choice of optimal polynomial pair of (x⁴+x+1, x²+x+8) results in the most compact Sbox in an embodiment.

Once the common composite field is selected, the second optimization stage determines the most area efficient transform that converts Camellia bytes from the standard specified composite field to the chosen GF(2⁴)². There are eight ways to transform Camellia's GF(2⁴)² to AES (GF(2⁸), and eight ways to transform AES GF(2⁸) to the common field of GF(2⁴)², resulting in 64 possible matrices. The GF(2⁸) field is a polynomials of order eight. Hence, it has eight roots, and for each root, there is a mapping matrix that can convert the input from GF(2)⁸ to GF(2⁴)². A similar exploration using SM4's GF(2⁸) field provides 64 more matrices.

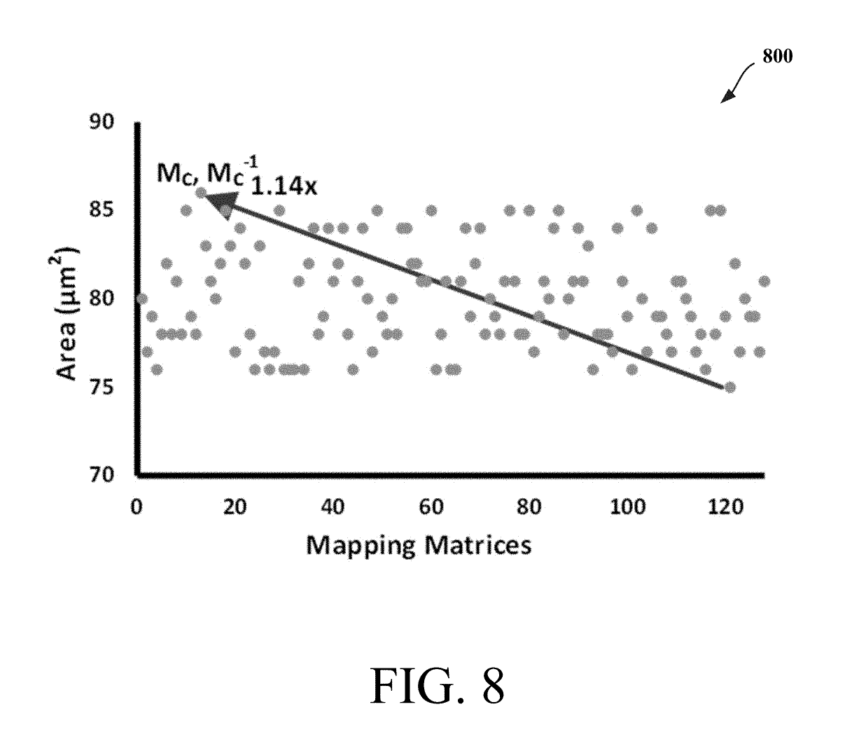

FIG. 8 illustrates a graph 800 which plots the area of the hybrid Sbox for all 128 cases, according to an embodiment. Moreover, there are 128 cases because there are 64 ways to convert CML to the unified field via the AES polynomial and another 64 ways to do so via the SM4 polynomial, so in total there are 128 cases. The plot indicates up to about 14% additional area savings. More particularly, plot 800 of FIG. 8 shows a hybrid Camellia-AES-SM4 Sbox area for different matrices that map Camellia bytes to the optimal field in one embodiment.

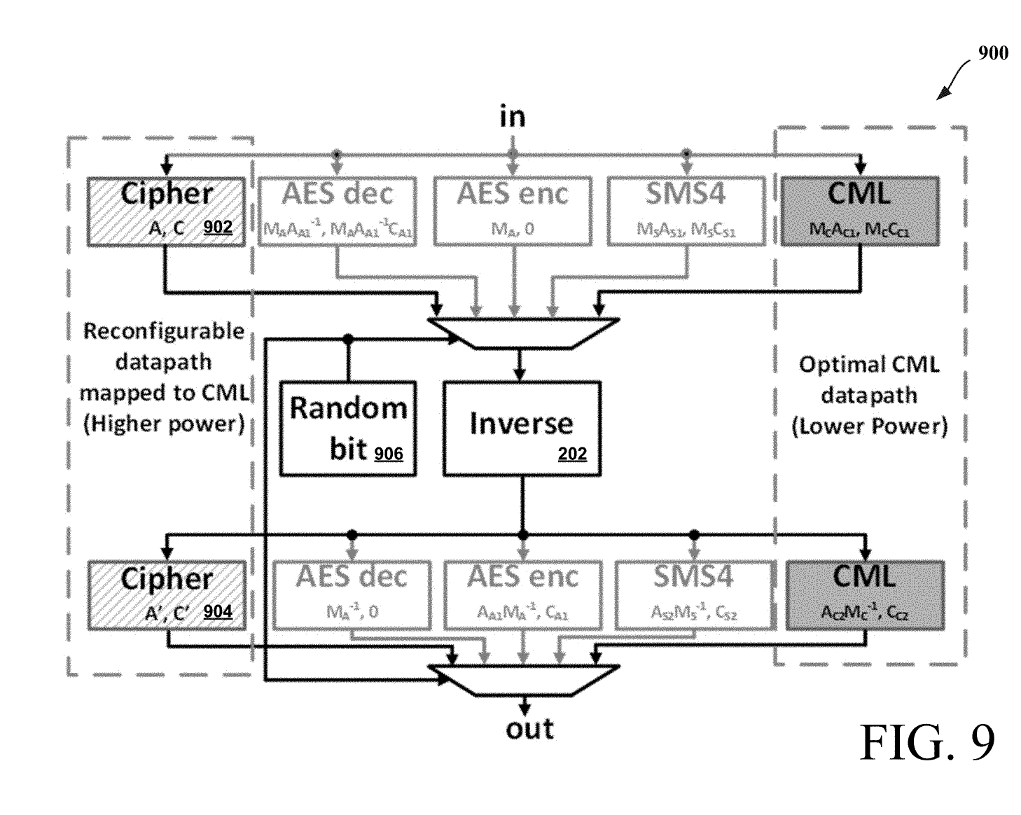

FIG. 9 illustrates a block diagram 900 for random switching between optimal and sub-optimal GF transforms for side-channel leakage mitigation, according to an embodiment. While operating in AES, SM4, or Camellia cipher modes, the reconfigurable matrices in FIG. 9 (A, C 902 and A′, C′ 904) can be programmed to generate a parallel datapath that is functionally equivalent (but higher power) to one of the optimally mapped AES/SM4/Camellia datapaths. A random bit or number 906 (e.g., generated by a random bit/number generator (not shown)) can be used to select/activate one of the datapaths (either cipher specific optimal or reconfigurable sub-optimal) for every Sbox operation to inject noise into the current signature. This breaks the correlation between Sbox power consumption and secret key bytes, while an attacker attempts to repeat signature measurements while providing a constant key byte.

In some embodiments, other side-channel mitigation schemes like dual rail logic implementation, key masking, integrated voltage regulator assisted noise injection etc. can be applied in addition to further improve resiliency to side-channel attacks. Although the embodiments described herein are targeted towards area reduction and/or energy-efficiency improvement in a multi-cipher usage scenario (which is becoming important for many products), the presence of reconfigurable features in such designs can also be opportunistically used to mitigate side-channel information leakage.

In an embodiment, only one cipher mode of operation can be enabled at a time, while an application can seamlessly transition to a different cipher in a single cycle by utilizing the hybrid Sbox design discussed herein. Hence, at least one embodiment relates to a technique to achieve high throughput energy-efficient Camellia, AES, SM4 encryption in SoC (System on Chip) devices with significant area savings by eliminating the need to develop separate accelerator engines for each cipher. The fully synthesizable design presented in this disclosure and automated optimization framework to reduce area in the context of different design constraints will ensure fast and seamless integration of multi-mode accelerators in a variety of logic products. Furthermore, the ability to incorporate new cipher acceleration in future without changing the hardware will improve time to market for many products.

As a result, some embodiments can provide a significant performance (e.g., ten-fold or more) improvement in implementing the Camellia encryption algorithm. Recently, hardware acceleration of SM4 has started being supported using a separate engine following the Chinese Govt. Security Agencies mandate to protect all wireless traffic data in China with SM4. In accordance with one or more embodiments, the hybrid Sbox approach can provide about 40% area savings by merging the AES and SM4 engines without impacting throughput. In a scenario where the use of Camellia becomes mandatory in Japan, some embodiments described herein can enable encryption acceleration in existing security systems relatively quickly in an area-efficient manner by maximizing re-use of existing resources.

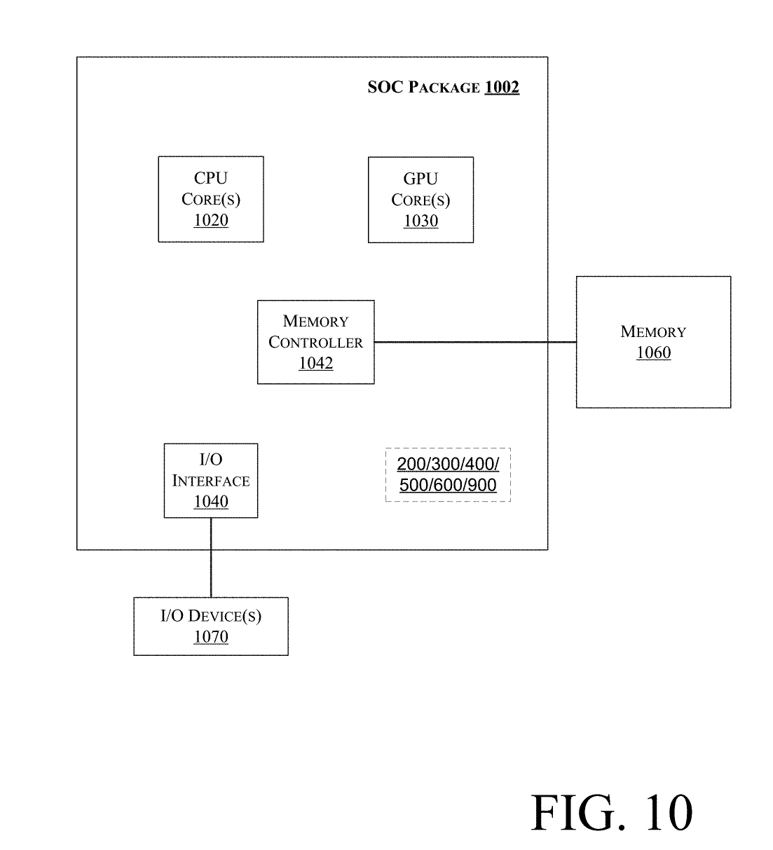

FIG. 10 illustrates a block diagram of an SOC package in accordance with an embodiment. As illustrated in FIG. 10, SOC 1002 includes one or more Central Processing Unit (CPU) cores 1020, one or more Graphics Processor Unit (GPU) cores 1030, an Input/Output (I/O) interface 1040, and a memory controller 1042. Various components of the SOC package 1002 may be coupled to an interconnect or bus such as discussed herein with reference to the other figures. Also, the SOC package 1002 may include more or less components, such as those discussed herein with reference to the other figures. Further, each component of the SOC package 1020 may include one or more other components, e.g., as discussed with reference to the other figures herein. In one embodiment, SOC package 1002 (and its components) is provided on one or more Integrated Circuit (IC) die, e.g., which are packaged into a single semiconductor device.

As illustrated in FIG. 10, SOC package 1002 is coupled to a memory 1060 via the memory controller 1042. In an embodiment, the memory 1060 (or a portion of it) can be integrated on the SOC package 1002.

The I/O interface 1040 may be coupled to one or more I/O devices 1070, e.g., via an interconnect and/or bus such as discussed herein with reference to other figures. I/O device(s) 1070 may include one or more of a keyboard, a mouse, a touchpad, a display, an image/video capture device (such as a camera or camcorder/video recorder), a touch screen, a speaker, or the like.

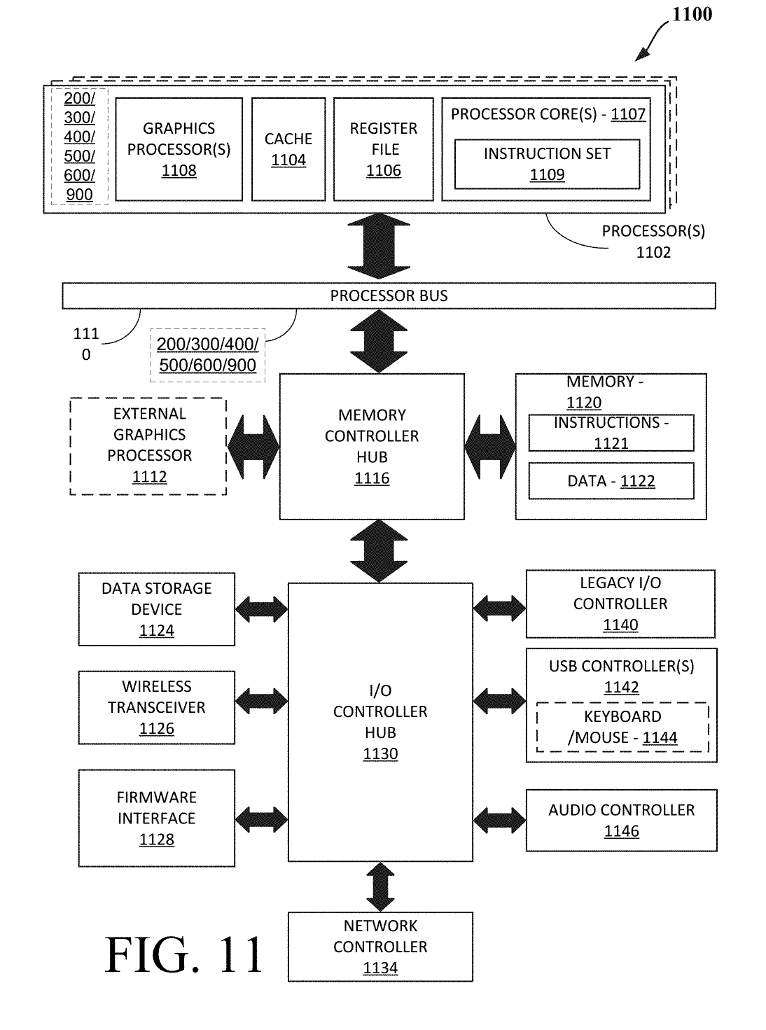

FIG. 11 is a block diagram of a processing system 1100, according to an embodiment. In various embodiments the system 1100 includes one or more processors 1102 and one or more graphics processors 1108, and may be a single processor desktop system, a multiprocessor workstation system, or a server system having a large number of processors 1102 or processor cores 1107. In on embodiment, the system 1100 is a processing platform incorporated within a system-on-a-chip (SoC or SOC) integrated circuit for use in mobile, handheld, or embedded devices.

An embodiment of system 1100 can include, or be incorporated within a server-based gaming platform, a game console, including a game and media console, a mobile gaming console, a handheld game console, or an online game console. In some embodiments system 1100 is a mobile phone, smart phone, tablet computing device or mobile Internet device. Data processing system 1100 can also include, couple with, or be integrated within a wearable device, such as a smart watch wearable device, smart eyewear device, augmented reality device, or virtual reality device. In some embodiments, data processing system 1100 is a television or set top box device having one or more processors 1102 and a graphical interface generated by one or more graphics processors 1108.

In some embodiments, the one or more processors 1102 each include one or more processor cores 1107 to process instructions which, when executed, perform operations for system and user software. In some embodiments, each of the one or more processor cores 1107 is configured to process a specific instruction set 1109. In some embodiments, instruction set 1109 may facilitate Complex Instruction Set Computing (CISC), Reduced Instruction Set Computing (RISC), or computing via a Very Long Instruction Word (VLIW). Multiple processor cores 1107 may each process a different instruction set 1109, which may include instructions to facilitate the emulation of other instruction sets. Processor core 1107 may also include other processing devices, such a Digital Signal Processor (DSP).

In some embodiments, the processor 1102 includes cache memory 1104. Depending on the architecture, the processor 1102 can have a single internal cache or multiple levels of internal cache. In some embodiments, the cache memory is shared among various components of the processor 1102. In some embodiments, the processor 1102 also uses an external cache (e.g., a Level-3 (L3) cache or Last Level Cache (LLC)) (not shown), which may be shared among processor cores 1107 using known cache coherency techniques. A register file 1106 is additionally included in processor 1102 which may include different types of registers for storing different types of data (e.g., integer registers, floating point registers, status registers, and an instruction pointer register). Some registers may be general-purpose registers, while other registers may be specific to the design of the processor 1102.

In some embodiments, processor 1102 is coupled to a processor bus 1110 to transmit communication signals such as address, data, or control signals between processor 1102 and other components in system 1100. In one embodiment the system 1100 uses an exemplary ‘hub’ system architecture, including a memory controller hub 1116 and an Input Output (I/O) controller hub 1130. A memory controller hub 1116 facilitates communication between a memory device and other components of system 1100, while an I/O Controller Hub (ICH) 1130 provides connections to I/O devices via a local I/O bus. In one embodiment, the logic of the memory controller hub 1116 is integrated within the processor.

Memory device 1120 can be a dynamic random access memory (DRAM) device, a static random access memory (SRAM) device, flash memory device, phase-change memory device, or some other memory device having suitable performance to serve as process memory. In one embodiment the memory device 1120 can operate as system memory for the system 1100, to store data 1122 and instructions 1121 for use when the one or more processors 1102 executes an application or process. Memory controller hub 1116 also couples with an optional external graphics processor 1112, which may communicate with the one or more graphics processors 1108 in processors 1102 to perform graphics and media operations.

In some embodiments, ICH 1130 enables peripherals to connect to memory device 1120 and processor 1102 via a high-speed I/O bus. The I/O peripherals include, but are not limited to, an audio controller 1146, a firmware interface 1128, a wireless transceiver 1126 (e.g., Wi-Fi, Bluetooth), a data storage device 1124 (e.g., hard disk drive, flash memory, etc.), and a legacy I/O controller 1140 for coupling legacy (e.g., Personal System 2 (PS/2)) devices to the system. One or more Universal Serial Bus (USB) controllers 1142 connect input devices, such as keyboard and mouse 1144 combinations. A network controller 1134 may also couple to ICH 1130. In some embodiments, a high-performance network controller (not shown) couples to processor bus 1110. It will be appreciated that the system 1100 shown is exemplary and not limiting, as other types of data processing systems that are differently configured may also be used. For example, the I/O controller hub 1130 may be integrated within the one or more processor 1102, or the memory controller hub 1116 and I/O controller hub 1130 may be integrated into a discreet external graphics processor, such as the external graphics processor 1112.

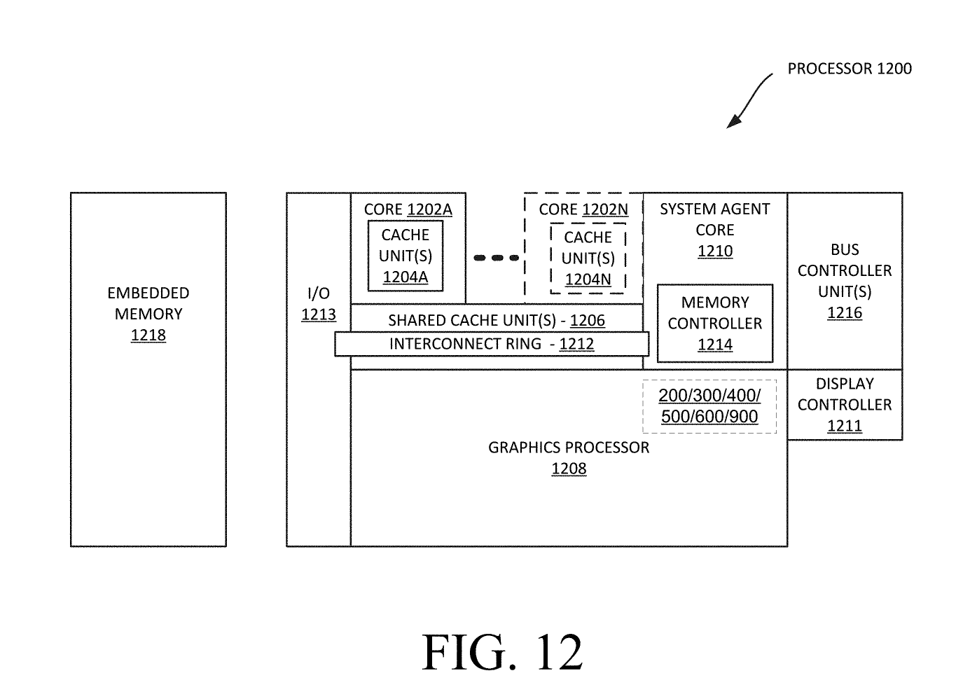

FIG. 12 is a block diagram of an embodiment of a processor 1200 having one or more processor cores 1202A to 1202N, an integrated memory controller 1214, and an integrated graphics processor 1208. Those elements of FIG. 12 having the same reference numbers (or names) as the elements of any other figure herein can operate or function in any manner similar to that described elsewhere herein, but are not limited to such. Processor 1200 can include additional cores up to and including additional core 1202N represented by the dashed lined boxes. Each of processor cores 1202A to 1202N includes one or more internal cache units 1204A to 1204N. In some embodiments each processor core also has access to one or more shared cached units 1206.

The internal cache units 1204A to 1204N and shared cache units 1206 represent a cache memory hierarchy within the processor 1200. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 1206 and 1204A to 1204N.

In some embodiments, processor 1200 may also include a set of one or more bus controller units 1216 and a system agent core 1210. The one or more bus controller units 1216 manage a set of peripheral buses, such as one or more Peripheral Component Interconnect buses (e.g., PCI, PCI Express). System agent core 1210 provides management functionality for the various processor components. In some embodiments, system agent core 1210 includes one or more integrated memory controllers 1214 to manage access to various external memory devices (not shown).

In some embodiments, one or more of the processor cores 1202A to 1202N include support for simultaneous multi-threading. In such embodiment, the system agent core 1210 includes components for coordinating and operating cores 1202A to 1202N during multi-threaded processing. System agent core 1210 may additionally include a power control unit (PCU), which includes logic and components to regulate the power state of processor cores 1202A to 1202N and graphics processor 1208.

In some embodiments, processor 1200 additionally includes graphics processor 1208 to execute graphics processing operations. In some embodiments, the graphics processor 1208 couples with the set of shared cache units 1206, and the system agent core 1210, including the one or more integrated memory controllers 1214. In some embodiments, a display controller 1211 is coupled with the graphics processor 1208 to drive graphics processor output to one or more coupled displays. In some embodiments, display controller 1211 may be a separate module coupled with the graphics processor via at least one interconnect, or may be integrated within the graphics processor 1208 or system agent core 1210.

In some embodiments, a ring based interconnect unit 1212 is used to couple the internal components of the processor 1200. However, an alternative interconnect unit may be used, such as a point-to-point interconnect, a switched interconnect, or other techniques, including techniques well known in the art. In some embodiments, graphics processor 1208 couples with the ring interconnect 1212 via an I/O link 1213.

The exemplary I/O link 1213 represents at least one of multiple varieties of I/O interconnects, including an on package I/O interconnect which facilitates communication between various processor components and a high-performance embedded memory module 1218, such as an eDRAM (or embedded DRAM) module. In some embodiments, each of the processor cores 1202 to 1202N and graphics processor 1208 use embedded memory modules 1218 as a shared Last Level Cache.

In some embodiments, processor cores 1202A to 1202N are homogenous cores executing the same instruction set architecture. In another embodiment, processor cores 1202A to 1202N are heterogeneous in terms of instruction set architecture (ISA), where one or more of processor cores 1202A to 1202N execute a first instruction set, while at least one of the other cores executes a subset of the first instruction set or a different instruction set. In one embodiment processor cores 1202A to 1202N are heterogeneous in terms of microarchitecture, where one or more cores having a relatively higher power consumption couple with one or more power cores having a lower power consumption. Additionally, processor 1200 can be implemented on one or more chips or as an SoC integrated circuit having the illustrated components, in addition to other components.

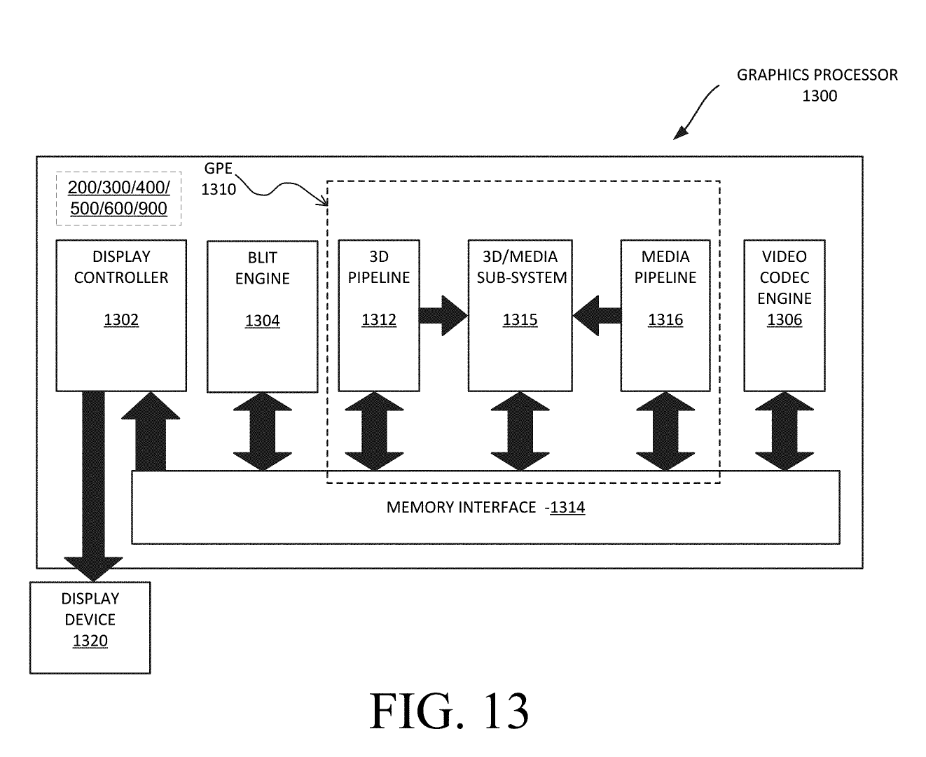

FIG. 13 is a block diagram of a graphics processor 1300, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 1300 includes a memory interface 1314 to access memory. Memory interface 1314 can be an interface to local memory, one or more internal caches, one or more shared external caches, and/or to system memory.

In some embodiments, graphics processor 1300 also includes a display controller 1302 to drive display output data to a display device 1320. Display controller 1302 includes hardware for one or more overlay planes for the display and composition of multiple layers of video or user interface elements. In some embodiments, graphics processor 1300 includes a video codec engine 1306 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 421M/VC-1, and Joint Photographic Experts Group (JPEG) formats such as JPEG, and Motion JPEG (MJPEG) formats.

In some embodiments, graphics processor 1300 includes a block image transfer (BLIT) engine 1304 to perform two-dimensional (2D) rasterizer operations including, for example, bit-boundary block transfers. However, in one embodiment, 13D graphics operations are performed using one or more components of graphics processing engine (GPE) 1310. In some embodiments, graphics processing engine 1310 is a compute engine for performing graphics operations, including three-dimensional (3D) graphics operations and media operations.

In some embodiments, GPE 1310 includes a 3D pipeline 1312 for performing 3D operations, such as rendering three-dimensional images and scenes using processing functions that act upon 3D primitive shapes (e.g., rectangle, triangle, etc.). The 3D pipeline 1312 includes programmable and fixed function elements that perform various tasks within the element and/or spawn execution threads to a 3D/Media sub-system 1315. While 3D pipeline 1312 can be used to perform media operations, an embodiment of GPE 1310 also includes a media pipeline 1316 that is specifically used to perform media operations, such as video post-processing and image enhancement.

In some embodiments, media pipeline 1316 includes fixed function or programmable logic units to perform one or more specialized media operations, such as video decode acceleration, video de-interlacing, and video encode acceleration in place of, or on behalf of video codec engine 1306. In some embodiments, media pipeline 1316 additionally includes a thread spawning unit to spawn threads for execution on 3D/Media sub-system 1315. The spawned threads perform computations for the media operations on one or more graphics execution units included in 3D/Media sub-system 1315.

In some embodiments, 3D/Media subsystem 1315 includes logic for executing threads spawned by 3D pipeline 1312 and media pipeline 1316. In one embodiment, the pipelines send thread execution requests to 3D/Media subsystem 1315, which includes thread dispatch logic for arbitrating and dispatching the various requests to available thread execution resources. The execution resources include an array of graphics execution units to process the 3D and media threads. In some embodiments, 3D/Media subsystem 1315 includes one or more internal caches for thread instructions and data. In some embodiments, the subsystem also includes shared memory, including registers and addressable memory, to share data between threads and to store output data.

The following examples pertain to further embodiments. Example 1 includes an apparatus comprising: first logic circuitry to perform a pre-affine operation on an input; second logic circuitry to perform an inverse operation on an output of the first logic circuitry; and third logic circuitry to perform a post-affine operation on an output of the second logic circuitry, wherein the inverse operation is to be performed based on a common field of Galois Field (GF) for a plurality of ciphers. Example 2 includes the apparatus of example 1, wherein the common composite field of GF is GF(24)2. Example 3 includes the apparatus of example 1, wherein the plurality of ciphers comprise two or more of: Advanced Encryption Standard (AES) cipher, SM4 cipher, and Camellia cipher. Example 4 includes the apparatus of example 1, wherein the pre-affine operation comprises two or more of: AES decryption pre-affine operation, AES encryption pre-affine operation, SM4 pre-affine operation, and Camellia pre-affine operation. Example 5 includes the apparatus of example 1, wherein the post-affine operation comprises two or more of: AES decryption post-affine operation, AES encryption post-affine operation, SM4 post-affine operation, and Camellia post-affine operation. Example 6 includes the apparatus of example 1, wherein the inverse operation is to be performed based on a 4-bit multiplication operation and an 8-bit reduction operation. Example 7 includes the apparatus of example 1, comprising logic to convert the plurality of ciphers into the common composite field of GF based on multiplication of a plurality of mapping matrices, wherein each of the plurality of mapping matrices corresponds to one of the plurality of ciphers. Example 8 includes the apparatus of example 7, comprising logic to merge the plurality of mapping matrices and a plurality of inverse mapping matrices into a plurality of affine matrices to generate a plurality of mapped affine transformations, wherein each of the plurality of affine matrices correspond to one of the pre-affine operation or the post-affine operation. Example 9 includes the apparatus of example 1, wherein a Substitute box (Sbox) comprises the first logic circuitry, the second logic circuitry, and the third logic circuitry. Example 10 includes the apparatus of example 9, wherein a processor, having one or more processor cores, comprises the Sbox. Example 11 includes the apparatus of example 9, wherein Sbox is capable to support a new cipher, in addition to the plurality of ciphers, based on two transformations for the pre-affine operation based on a reconfigurable pre-affine matrix and a reconfigurable post-affine matrix. Example 12 includes the apparatus of example 1, comprising logic to switch between two GF transforms based on a status of a bit to mitigate side-channel leakage. Example 13 includes the apparatus of example 12, comprising logic to randomly generate the bit. Example 14 includes a method comprising: performing, at first logic, a pre-affine operation on an input; performing, at second logic, an inverse operation on an output of the first logic; and performing, at third logic, a post-affine operation on an output of the second logic, wherein the inverse operation is performed based on a common field of Galois Field (GF) for a plurality of ciphers. Example 15 includes the method of example 14, wherein the common composite field of GF is GF(24)2. Example 16 includes the method of example 14, wherein the plurality of ciphers comprise two or more of: Advanced Encryption Standard (AES) cipher, SM4 cipher, and Camellia cipher. Example 17 includes the method of example 14, wherein the pre-affine operation comprises two or more of: AES decryption pre-affine operation, AES encryption pre-affine operation, SM4 pre-affine operation, and Camellia pre-affine operation. Example 18 includes the method of example 14, wherein the post-affine operation comprises two or more of: AES decryption post-affine operation, AES encryption post-affine operation, SM4 post-affine operation, and Camellia post-affine operation. Example 19 includes the method of example 14, wherein the inverse operation is performed based on a 4-bit multiplication operation and an 8-bit reduction operation. Example 20 includes the method of example 14, further comprising converting the plurality of ciphers into the common composite field of GF based on multiplication of a plurality of mapping matrices, wherein each of the plurality of mapping matrices corresponds to one of the plurality of ciphers.

Example 21 includes one or more non-transitory computer-readable medium comprising one or more instructions that when executed on a processor configure the processor to perform one or more operations to: perform, at first logic, a pre-affine operation on an input; perform, at second logic, an inverse operation on an output of the first logic; and perform, at third logic, a post-affine operation on an output of the second logic, wherein the inverse operation is performed based on a common field of Galois Field (GF) for a plurality of ciphers. Example 22 includes the one or more computer-readable medium of example 21, wherein the common composite field of GF is GF(24)2. Example 23 includes the one or more computer-readable medium of example 21, wherein the plurality of ciphers comprise two or more of: Advanced Encryption Standard (AES) cipher, SM4 cipher, and Camellia cipher. Example 24 includes the one or more computer-readable medium of example 21, wherein the pre-affine operation comprises two or more of: AES decryption pre-affine operation, AES encryption pre-affine operation, SM4 pre-affine operation, and Camellia pre-affine operation. Example 25 includes the one or more computer-readable medium of example 21, wherein the post-affine operation comprises two or more of: AES decryption post-affine operation, AES encryption post-affine operation, SM4 post-affine operation, and Camellia post-affine operation.

Example 26 includes an apparatus comprising means to perform a method as set forth in any preceding example. Example 27 includes machine-readable storage including machine-readable instructions, when executed, to implement a method or realize an apparatus as set forth in any preceding example.

In various embodiments, the operations discussed herein, e.g., with reference to FIG. 1 et seq., may be implemented as hardware (e.g., logic circuitry or more generally circuitry or circuit), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIG. 1 et seq.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
first logic circuitry to perform a pre-affine operation on an input;
second logic circuitry to perform an inverse operation on an output of the first logic circuitry; and
third logic circuitry to perform a post-affine operation on an output of the second logic circuitry,
wherein the inverse operation is to be performed based on a common field of Galois Field (GF) for a plurality of ciphers.

2. The apparatus of claim 1, wherein the common composite field of GF is GF(2⁴)².

3. The apparatus of claim 1, wherein the plurality of ciphers comprise two or more of:
Advanced Encryption Standard (AES) cipher, SM4 cipher, and Camellia cipher.

4. The apparatus of claim 1, wherein the pre-affine operation comprises two or more of: AES decryption pre-affine operation, AES encryption pre-affine operation, SM4 pre-affine operation, and Camellia pre-affine operation.

5. The apparatus of claim 1, wherein the post-affine operation comprises two or more of: AES decryption post-affine operation, AES encryption post-affine operation, SM4 post-affine operation, and Camellia post-affine operation.

6. The apparatus of claim 1, wherein the inverse operation is to be performed based on a 4-bit multiplication operation and an 8-bit reduction operation.

7. The apparatus of claim 1, comprising logic to convert the plurality of ciphers into the common composite field of GF based on multiplication of a plurality of mapping matrices, wherein each of the plurality of mapping matrices corresponds to one of the plurality of ciphers.

8. The apparatus of claim 7, comprising logic to merge the plurality of mapping matrices and a plurality of inverse mapping matrices into a plurality of affine matrices to generate a plurality of mapped affine transformations, wherein each of the plurality of affine matrices correspond to one of the pre-affine operation or the post-affine operation.

9. The apparatus of claim 1, wherein a Substitute box (Sbox) comprises the first logic circuitry, the second logic circuitry, and the third logic circuitry.

10. The apparatus of claim 9, wherein a processor, having one or more processor cores, comprises the Sbox.

11. The apparatus of claim 9, wherein Sbox is capable to support a new cipher, in addition to the plurality of ciphers, based on two transformations for the pre-affine operation based on a reconfigurable pre-affine matrix and a reconfigurable post-affine matrix.

12. The apparatus of claim 1, comprising logic to switch between two GF transforms based on a status of a bit to mitigate side-channel leakage.

13. The apparatus of claim 12, comprising logic to randomly generate the bit.

14. A method comprising:
performing, at first logic, a pre-affine operation on an input;
performing, at second logic, an inverse operation on an output of the first logic; and
performing, at third logic, a post-affine operation on an output of the second logic,
wherein the inverse operation is performed based on a common field of Galois Field (GF) for a plurality of ciphers.

15. The method of claim 14, wherein the common composite field of GF is GF(2⁴)².

16. The method of claim 14, wherein the plurality of ciphers comprise two or more of:
Advanced Encryption Standard (AES) cipher, SM4 cipher, and Camellia cipher.

17. The method of claim 14, wherein the pre-affine operation comprises two or more of:
AES decryption pre-affine operation, AES encryption pre-affine operation, SM4 pre-affine operation, and Camellia pre-affine operation.

18. The method of claim 14, wherein the post-affine operation comprises two or more of: AES decryption post-affine operation, AES encryption post-affine operation, SM4 post-affine operation, and Camellia post-affine operation.

19. The method of claim 14, wherein the inverse operation is performed based on a 4-bit multiplication operation and an 8-bit reduction operation.

20. The method of claim 14, further comprising converting the plurality of ciphers into the common composite field of GF based on multiplication of a plurality of mapping matrices, wherein each of the plurality of mapping matrices corresponds to one of the plurality of ciphers.

21. One or more non-transitory computer-readable medium comprising one or more instructions that when executed on a processor configure the processor to perform one or more operations to:
perform, at first logic, a pre-affine operation on an input;
perform, at second logic, an inverse operation on an output of the first logic; and
perform, at third logic, a post-affine operation on an output of the second logic,
wherein the inverse operation is performed based on a common field of Galois Field (GF) for a plurality of ciphers.

22. The one or more computer-readable medium of claim 21, wherein the common composite field of GF is GF(2⁴)².

23. The one or more computer-readable medium of claim 21, wherein the plurality of ciphers comprise two or more of: Advanced Encryption Standard (AES) cipher, SM4 cipher, and Camellia cipher.

24. The one or more computer-readable medium of claim 21, wherein the pre-affine operation comprises two or more of: AES decryption pre-affine operation, AES encryption pre-affine operation, SM4 pre-affine operation, and Camellia pre-affine operation.

25. The one or more computer-readable medium of claim 21, wherein the post-affine operation comprises two or more of: AES decryption post-affine operation, AES encryption post-affine operation, SM4 post-affine operation, and Camellia post-affine operation.
